(19) United States
(12) Patent Application Publication
(10) Pub. No.: US 2026/0238114 A1
(43) Pub. Date: Aug. 13, 2026

(54) MULTI-PHASE CONVERTER AND METHOD FOR PHASE LOAD BALANCING

(71) Applicant: BRUSA HYPOWER AG, Buchs (CH)

(72) Inventor: Axel KRAUSE, Nesslau (CH)

(21) Appl. No.: 19/160,735

(22) PCT Filed: Feb. 29, 2024
(86) PCT No.: PCT/EP2024/055259

§ 371 Date: Aug. 28, 2025

(30) Foreign Application Priority Data
Mar. 2, 2023 (DE) 10 2023 105 145.8

(51) Int. Cl. H02M 1/084; H02M 1/00; H02M 1/08; H02M 1/15; H02M 1/42; H02M 3/335

(52) U.S. Cl. CPC H02M 1/084; H02M 1/0009; H02M 1/081; H02M 1/15; H02M 1/4233; H02M 3/33571

(57) ABSTRACT

A multi-phase converter for phase load balancing including a converter circuit with three phase contacts and a controller to closed-loop control an assigned input phase current in each of the three phase contacts to a predefined input phase current setpoint I1, I2, I3, wherein the input phase current setpoints I1, I2, I3 as vectorial variables each with a current magnitude I1, I2, I3 and a phase shift φ1, φ2, φ3 are determined in a manner such that the current magnitudes of the input phase current setpoints I1, I2, I3 are each smaller or equal to an assigned maximal current magnitude I1d, I2d, I3d, hereinafter also called current limit value; a power which flows into the converter circuit at the phase contacts is maximised; and, optionally, specified constraints on the phase shifts of the input phase currents are satisfied.

### CROSS REFERENCE TO RELATED APPLICATIONS

The present application is the U.S. National Phase of PCT/EP2024/055259, filed on 29 Feb. 2024, which claims priority to German Patent Application No. 10 2023 105 145.8, filed on 2 Mar. 2023, the entire contents of which are incorporated herein by reference.

### BACKGROUND

### Field

The invention relates to the field of electronic power converters, and in particular, relates to a multi-phase converter for phase load balancing and to a method for the phase load balancing, according to the preamble of the respective independent patent claims.

### Related Art

On-board charging devices for electrical vehicles (called on-board chargers or OBCs) can be connected to a three-phase mains in the case that a respective mains is present. Ideally, the power requirement at each mains phase is balanced, i.e., all phase currents with which the charging device is fed are equal. For example, an 11 kW charging device for an electric vehicle on a mains with thrice 230 V rated voltage obtains 16 A per phase, which is sufficient for a complete charging overnight.

The load capacity of one or more phases however can be limited under certain circumstances, for example, on account of another, high load, for example, a hot water boiler, an air-conditioning facility, etc. If, for example, the maximal current per phase is 20 A, and a hot water boiler at night draws 10 A from a phase, then the charging device must reduce the power at this phase to 10 A or less. This can be realised by way of the three-phase charging device consisting of three single-phase charging devices which are each connected as a load between phase and neutral conductor. Herein, each of the three single-phase charging devices can realise a power factor correction circuit (PFC), in order to comply with the regulations concerning the limiting of the harmonics of the respective phase current. Hence, the three-phase charging device comprises three PFCs, each between phase and neutral conductor.

WO 2018/176184 describes a voltage sampling circuit in a three-phase PCF mains.

U.S. Pat. No. 8,788,106 B2 describes the distribution of electrical power onto several devices for de-icing an aircraft wing according to a power demand of each of the devices. The devices are resistive heating elements in an electrical three-phase system. A constraint on the operation of the devices is maintaining a neutral conductor current below a limit value.

EP 3 435 533 A1 describes an electrical three-phase system with individual AC-DC phase modules in an AC-side star configuration. A method for the closed-loop control of the voltage at the star point is disclosed. A similar method is also described in AU 2015203405 A1.

DE 10 2019 105661 A1 teaches the balancing of an asymmetrical loading of a multi-phase system by way of a plurality of consumers, firstly by way of redistribution of the consumers onto the phases. A residual asymmetry is compensated by an active rectifier which feeds a further consumer. The aim is to achieve a symmetrical three-phase current system at the supply phases.

### SUMMARY

It is the object of the invention to provide a multi-phase converter for phase load balancing and a method for the phase load balancing, of the initially mentioned type, such with regard to circuit technology requiring a lower effort concerning the power components compared to existing solutions.

This object is achieved by a multi-phase converter for the phase load balancing and a method for the phase load balancing, with the features of the respective independent patent claims.

The multi-phase converter serves for the phase load balancing. It includes a converter circuit and a controller, wherein the converter circuit comprises three or more phase contacts and is designed to feed a consumer, wherein the controller is designed to control the converter circuit and by way of this to closed-loop control an assigned input phase current in each of the three phase contacts to a predefined input phase current setpoint I1, I2, I3.

Herein, the controller is designed, on operation of the converter circuit, to determine the input phase current setpoints I1, I2, I3 as vectorial variables each with a current magnitude I1, I2 I3 and a phase shift φ1, φ2, φ3, in a manner such that
the current magnitudes of the input phase current setpoints I1, I2, I3 are each smaller or equal to an assigned maximal current magnitude I1d, I2d, I3d, hereinafter also called current limit value;
a power which flows into the converter circuit at the phase contacts is maximised;
and, optionally, specified constraints on the phase shifts of the input phase currents are satisfied.

The converter circuit here and hereinafter is described by way of example as including three phase contacts. However, it can also be realised with more than three phase contacts, in particular, with six.

The consumer can be fed via a lower contact point and an upper contact point. The feeding of the consumer can be realised by way of the converter circuit being designed to selectively lead currents from each of the three phase contacts onto the lower or the upper contact point. In particular, the converter circuit is configured to connect each of the three phase contacts to a lower contact point or to an upper contact point of the one consumer.

The fact that the controller is designed to determine the input phase current setpoints as vectorial variables each with a current magnitude and a phase shift means that the input currents are sinusoidal and form a three-phase system or a system with more than three phases.

It is possible with this multi-phase converter to form the input currents such that a balanced system with three or more phases forms, the system requiring no balancing current by a neutral conductor. In particular, however, there is also no real star point in the converter circuit. Herewith, one cannot apply known approaches for controlling the converter circuit.

The costs and the size of the EV charging device can be reduced by the application of a three-phase charging device which requires no neutral conductor contact. As an example, a three-phase converter can be used as a PFC, and in the manner which is described here the converter can be controlled such that it forms, for example, a non-symmetrical load which compensates an existing, given loading of the mains.

Due to the fact that no neutral conductor is present, the possibilities for a non-symmetrical phase loading are very much reduced with a three-phase PFC. In this restricted scope, a defined power can be obtained from the three-phase mains with the described three-phase converter whilst taking into account individual limit values for all three phase currents. This can be the maximally available power. If not, then one degree of freedom remains, in order to obtain the demanded power with a balanced as possible loading of the phases. These limit values can result from the loading of the phases by other consumers.

In order to selectively connect one of the input contacts to a lower contact point or an upper contact point of a consumer, a half-bridge branch which is assigned to the respective input contact can be present. For this, a half-bridge branch can include a lower switch and a lower flyback diode which are connected between a centre tap of the half-bridge branch and the lower contact point, as well as an upper switch and an upper flyback diode which are connected between the centre tap of the half-bridge branch and the upper contact point. The centre tap can be connected to the corresponding input contact via a smoothing inductor.

In embodiments therefore, the three or more phase contacts form primary-side contacts for feeding a multi-phase converter, and the multi-phase converter includes no primary-side contact for a neutral conductor.

In embodiments, the controller is designed, in a verification step to determine whether current magnitudes of the input phase current setpoints I1, I2, I3 can be realised, wherein these are each equal to the assigned current limit value I1d, I2d, I3d, and to otherwise reduce the current magnitude whose current limit value is the largest of the current limit values.

In a three-phase system, the verification step and the adaption which is possibly to be carried out can be realised, amid the assumption that the largest maximal current magnitude with regard to magnitude is denoted by I3d, by way of setting I1=I1d and I2=I2d and I3=min(I3d; \sqrt{I1²+I1·I2+I2²}). The verification step therefore corresponds to a check as to whether I3d is smaller than the square root term.

In embodiments, the controller is designed to determine the current magnitudes of the input phase current setpoints I1, I2, I3 on the basis of fictitious delta current magnitudes J1, J2, J3, wherein the following equations apply

$$I {1}^{2} = J {1}^{2} + J {2}^{2} + J 1 \cdot J 2 ,$$

$$I {2}^{2} = J {2}^{2} + J {3}^{2} + J 2 \cdot J 3 ,$$

$$I {3}^{2} = J {3}^{2} + J {1}^{2} + J 3 \cdot J 1.$$

The maximal possible power on account of the limited phase currents is unambiguously defined as the solution to this equation system. The three input phase current setpoints I1, I2, I3 are specified, and the fictive delta current magnitudes J1, J2, J3 are to be determined. In particular, the solution is unambiguous inasmuch as it is assumed that the phase shifts of the currents with respect to the voltages lie in the range of +30° to −30°, and if the largest current magnitude is limited according to I3=min(I3d; \sqrt{I1²+I1·I2+I2²}).

If the demanded power is to be lower than the maximal possible power, then one can select an operating point which effects the smallest power ripple.

For this, in embodiments the multi-phase converter is designed for the closed-loop control of the converter circuit to a maximal power uptake at the phase contacts, with the constraint that the current magnitudes of the input phase current setpoints are equal.

In embodiments, the controller is configured to store or receive load limitation information on at least one of the phase contacts, and to reduce the current limit value of this phase contact in accordance with this load limitation information.

Further preferred embodiments are to be derived from the dependent patent claims. Herein, the features of the method claims regarding context can be combined with the device claims and vice versa.

### BRIEF DESCRIPTION OF THE DRAWINGS

The subject-matter of the invention is hereinafter explained in more detail by way of preferred embodiment examples which are represented in the accompanying drawings. Each in a schematic manner is shown:

FIG. 1 a charging device with a three-phase converter without a neutral point;

FIG. 2 the three-phase converter with an assigned controller,

FIG. 3 voltages and currents at phase contacts of the three-phase converter;

FIG. 4 a three-phase mains with a defined load between a phase and a star point;

FIG. 5 currents in this mains on optimising the three-phase converter to maximal power uptake;

FIG. 6 a three-phase mains with a defined load between a phase and a start point; and

FIG. 7 currents in this mains on optimising the three-phase converter to balanced feed currents.

Basically, equal or equally functioning parts are provided with the same reference numerals in the figures.

### DETAILED DESCRIPTION

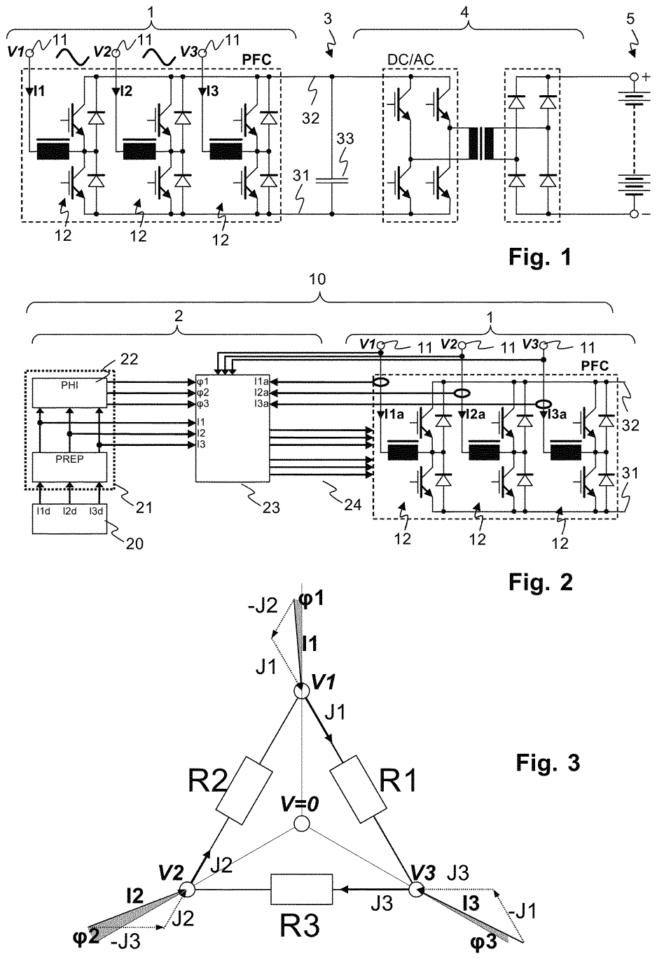

FIG. 1 shows a charging device with a three-phase converter without a neutral point, hereinafter also denoted as a converter circuit 1. The converter circuit 1 includes an input side or mains side with three phase contacts 11. Each of the phase contacts 11, typically via a choke, leads to a centre tap of an assigned bridge branch 12. Each bridge branch 12 connects a current of the respective phase contact selectively to a lower contact point 31 or upper contact point 32 of the converter circuit 1. These contact points are connected by an intermediate circuit capacitance 33 and feed a DC-DC converter 4 which in turn feeds a battery 5. The inner structure of the converter circuit 1 and of the DC-DC converter 4 is not decisive for the realisation. The converter circuit 1 merely needs to be at least capable of setting the currents which flow through the phase contacts 11. In particular, with the help of a controller it is capable of setting a sinusoidal course of each of the currents each with a settable amplitude and a phase shift.

FIG. 2 shows the converter circuit with an assigned controller 2. This includes a gate signal generation 23 which
as control input signals, receives the amplitudes and phase shifts of the input phase currents I1, I2, I3 as setpoints
receives measured phase currents I1a, I2a, I3a and phase voltages V1, V2, V3 as measurement values, and
outputs gate signals 24 to the converter circuit 1 as command signals.

The setpoints are determined by a pre-processing stage 21 which receives current limit values I1d, I2d, I3d from a unit for current maximal value acquisition 20. The input phase current setpoints I1, I2, I3 are determined from these current limit values in a pre-processing stage 21. It is from these that the setpoints for the phase shifts φ1, φ2, φ3 are determined in a phase shift evaluation 22.

The current limit values I1d, I2d, I3d can be specified by the feeding electrical distribution grid and be transmitted to the multi-phase converter 10. Electrical distribution grids with means for detecting consumption values, for switching or controlling consumers and for transmitting data concerning the state of the mains are known as a smart grid. Such a smart grid can herewith transmit the maximally obtainable power or the maximal allowable current per phase to the multi-phase converter 10.

At least one load which is static or varies dynamically in a switched-on and switched-off or continuous manner, hereinafter called external load, can be connected to one or more of the phases, via which the multi-phase converter is also fed. The maximal current which is still yet available to the multi-phase converter is limited by this external load. For example, for an 11 kW charging device, one of the phase currents can be limited to 10 A, the others not, i.e., a nominal phase current of 16 A can be obtained at the others. Information on the state of the external load can be incorporated in the current limitation values I1d, I2d, I3d by the smart grid.

By way of the pre-processing stage 21 it is examined:
Can the current limit values I1d, I2d, I3d be realised? For example, the combination I3d=16 A, I1d=I2d=6 A cannot be realised.
If they cannot be realised, what are the realisable current magnitudes I1, I2, I3 for the input phase current setpoints which result in a maximal charging power? In the mentioned example, these are I3=10.4 A, I1=I2=6 A. Herein, I3=min(I3d; {square root over (I1²+I1·I2+I2²))}.

The phase shift evaluation 22 determines the phase shifts φ1, φ2, φ3 in the following manner, explained by way of FIG. 3. This shows voltages and currents at the input terminals of the converter circuit 1. Considered from the phase contacts 11, the converter circuit 1 can be equated to a delta circuit of resistors. The figure shows a combination of phasor diagrams of the voltages V1, V2, V3 at the phase contacts 11 and of the phase currents I1, I2, I3 which flow into the phase contacts 11 (conventionally, vectorial variables are printed in bold). Fictitious delta currents flow in the equivalent circuit, with a mutual phase shift of 120° and with the magnitudes J1, J2, J3. The delta currents vectorially sum into the flowing-in currents (phase currents) at the contact points of the equivalent circuit. The vectorial sum of the currents which flow in should be zero since no zero conductor is present. It is from this condition and the vectorial sums that equations result, from which the phase shifts φ1, φ2, φ3 of the phase currents at a given magnitude I1, I2, I3 of the phase currents are determined. By application of a cosine law, these equations are

$$I {1}^{2} = J {1}^{2} + J {2}^{2} + J 1 \cdot J 2 ,$$

$$I {2}^{2} = J {2}^{2} + J {3}^{2} + J 2 \cdot J 3 ,$$

$$I {3}^{2} = J {3}^{2} + J {1}^{2} + J 3 \cdot J 1.$$

These equations can generally all be solved by a numerical approximation method based on the magnitudes J1, J2, J3 of the delta currents. Analytic solutions are possible in individual cases, for example, if two of the phase currents are equal. This is the case if an external load is only connected to one of the phases.

With the magnitudes J1, J2, J3 of the delta currents and whilst applying the cosine law to the delta currents in FIG. 3, the phase shifts of the input phase current setpoints result as

$${φ}_{1} = 30 ° - arccos \frac{I {1}^{2} + J {1}^{2} - J {2}^{2}}{2 I 1 \cdot J 1} ,$$

$${φ}_{2} = 30 ° - arccos \frac{I {2}^{2} + J {2}^{2} - J {3}^{2}}{2 I 2 \cdot J 2} ,$$

$${φ}_{3} = 30 ° - arccos \frac{I {3}^{2} + J {3}^{2} - J {1}^{2}}{2 I 3 \cdot J 3} .$$

The solutions are unambiguous if it is assumed that the phase shifts of the currents with respect to the voltages lie in the range of +30° to −30°, and if the largest current magnitude is limited for example according to I3=min(I3d; {square root over (I1²+I1·I2+I2²))}.

Mathematically equivalent methods which on implementation in reality lead to the same result can be carried out. For example, on computation, the values can be normalised to one of the current magnitude values.

If certain operating situations are known beforehand, the solutions to the equations can be computed beforehand and be stored in the controller, and be retrieved given the occurrence of such an operating situation. This can be the case, e.g., given an external load which only has a limited number of load stages, for example, a boiler which is switched on and off.

Concluding therefore, starting from the specified current limit values I1d, I2d, I3d, if necessary the highest current magnitude is reduced, so that a physically realisable solution for the phase shifts of the three currents with which the currents complement one another into zero exists. This results in the current magnitudes of the input phase current setpoints I1, I2, I3. From this, the setpoints for the phase shifts φ1, φ2, φ3 of the phase currents are determined via the fictitious delta current magnitudes. These are used by the gate signal generation 23 for the closed-loop control of the converter circuit 1. Herewith, as a result a maximal power uptake of the converter circuit 1 is realised. The power uptake can be computed in the known manner as the sum of the power which flows into the converter circuit 1 at each phase contact 11. This in turn in each case is the product of the voltage and of the current at the phase contact 11, multiplied by the cosine of its phase shift.

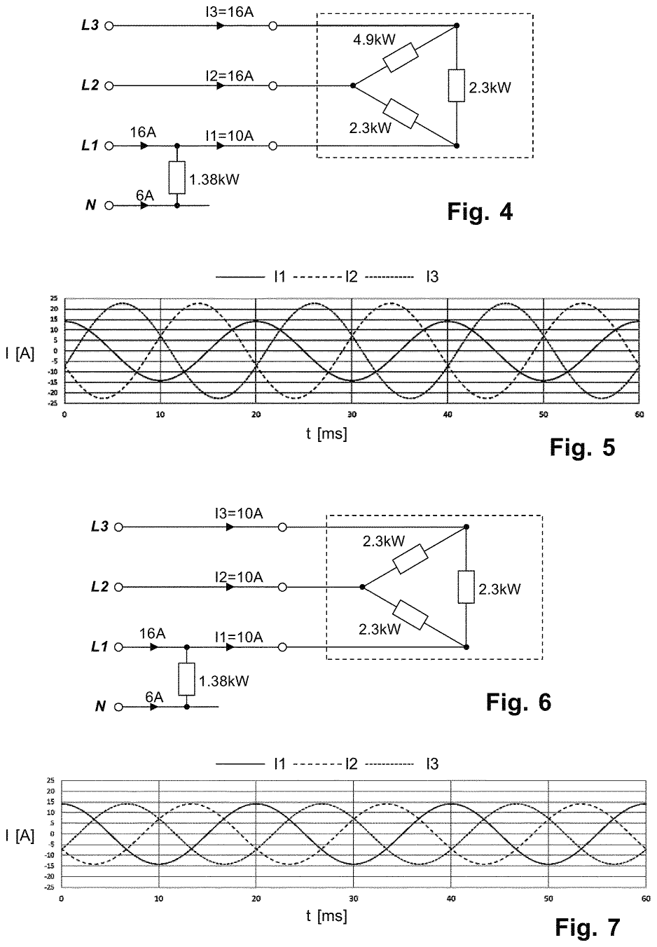

FIG. 4 shows a three-phase mains with a specified load between a phase and a star point, and FIG. 5 shows the currents in this mains on controlling the three-phase converter to maximal power uptake. By way of example, a 230V/400 three-phase mains is present. A uniform mains loading each with 16 A per phase is realised. The converter obtains a maximal possible mains power of 9.5 kW. Herein, one phase can only be loaded to a reduced extent on account of an additional external load with respect to the neutral conductor.

As an alternative to the maximal power uptake, the phase currents can be selected such that a ripple at the input of the converter circuit 1 is minimised. For this, the three input phase current setpoints I1, I2, I3 are set equally to one another and set to the smallest value of the three current limit values I1d, I2d, I3d. The fluctuation of the taken-up power over a full wave (“power ripple”) is herewith kept as small as possible.

FIG. 6 shows the same three-phase mains, and FIG. 7 shows currents in this mains on controlling the three-phase converter to a balanced power at the converter. A uniform device loading of the converter is therefore realised. The highest possible power results at 6.9 kW given an identical loading of all three phases at the device input; in this case, all three phases draw the current from the least loadable phase.

In embodiments, an intermediate solution with respect to the maximal power uptake and the uniform device loading of the converter can be realised. If, for example, the demanded power is to be smaller than the maximal possible power, then a “best balancing” can be considered as the operating point which effects the smallest power ripple. One example is the power limited to 6 kW, a phase current to 10 A and the other two to 16 A. The one phase can then be loaded with 10 A and the other two with about 7.5 A, which generates a power ripple, or all three phases are loaded with 8.7 A which effects a symmetrical loading and herewith ripple-free power.

Alternatively, one can close-loop control to an at least approximately uniform loading of the feeding mains (not represented). For this, information on the loading due to the asymmetric load must be present.

1. A multi-phase converter for phase load balancing, the multi-phase converter comprising:
a converter circuit comprising three or more phase contacts and designed to feed a consumer; and
a controller is designed to control the converter circuit and by way of this to closed-loop control an assigned input phase current in each of the three phase contacts to a predefined input phase current setpoint I1, I2, I3, wherein the controller is designed, on operation of the converter circuit and for each of the phase contacts, to receive by transmission a respectively assigned maximal current magnitude I1, I2, I3, hereinafter also called current limit value, and to determine the input phase current setpoints I1, I2, I3 as vectorial variables each with a current magnitude I1, I2 I3 and a phase shift φ1, φ2, φ3, in a manner such that
the current magnitudes of the input phase current setpoints I1, I2, I3 are each smaller or equal to the assigned current limit value I1d, I2d, I3d;
an effective power which flows into the converter circuit at the phase contacts is maximised; and
specified constraints on the phase shifts of the input phase currents are satisfied.

2. The multi-phase converter according to claim 1, wherein the three or more phase contacts form primary-side contacts for feeding the multi-phase converter and the multi-phase converter comprises no primary-side contact for a neutral conductor.

3. The multi-phase converter for phase load balancing according to claim 1, wherein in a verification step the controller is designed to:
determine whether current magnitudes of the input phase current setpoints I1, I2, I3 are capable of being realised, wherein these are each equal to the assigned current limit value I1d, I2d, I3d; and
otherwise to reduce the current magnitude whose current limit value is the largest of the current limit values.

4. The multi-phase converter for phase load balancing according claim 1, wherein the controller is designed to determine the current magnitudes of the input phase current setpoints I1, I2, I3 based on fictitious delta current magnitudes J1, J2, J3, wherein the following equations apply
$$I {1}^{2} = J {1}^{2} + J {2}^{2} + J 1 \cdot J 2 ,$$
$$I {2}^{2} = J {2}^{2} + J {3}^{2} + J 2 \cdot J 3 ,$$
$$I {3}^{2} = J {3}^{2} + J {1}^{2} + J 3 \cdot J 1.$$

5. The multi-phase converter for phase load balancing according to claim 4, wherein the controller is designed to determine the phase shifts of the input phase current setpoints as
$${φ}_{1} = 30 ° - arccos \frac{I {1}^{2} + J {1}^{2} - J {2}^{2}}{2 I 1 \cdot J 1} ,$$
$${φ}_{2} = 30 ° - arccos \frac{I {2}^{2} + J {2}^{2} - J {3}^{2}}{2 I 2 \cdot J 2} ,$$
$${φ}_{3} = 30 ° - arccos \frac{I {3}^{2} + J {3}^{2} - J {1}^{2}}{2 I 3 \cdot J 3} .$$

6. The multi-phase converter according to claim 1, designed for the closed-loop control of the converter circuit to a maximal power uptake at the phase contacts, with a constraint that the current magnitudes of the input phase current setpoints I1, I2, I3 are equal.

7. The multi-phase converter according to claim 1, wherein the controller is configured to store or receive load limitation information on at least one of the phase contacts, and to reduce the current limit value of this phase contact in accordance with the load limitation information.

8. A method of operating a multi-phase converter for phase load balancing, the multi-phase converter comprising a converter circuit that comprises three or more phase contacts and is designed to feed a consumer, and a controller that controls the converter circuit and by way of this closed-loop controls an assigned input phase current in each of the three phase contacts to a predefined input phase current setpoint I1, I2, I3, wherein the method comprises:
receiving by transmission at the controller a respectively assigned maximal current magnitude I1d, I2d, I3d, hereinafter also called current limit value, for each of the phase contacts; and
determining via the controller the input phase current setpoints I1, I2, I3 as vectorial variables each with a current magnitude I1, I2 I3 and a phase shift φ1, φ2, φ3, in a manner such that
the current magnitudes of the input phase current setpoints I1, I2, I3 are each smaller or equal to the assigned current limit value I1d, I2d, I3d;
an effective power which flows into the converter circuit at the phase contacts is maximised; and
specified constraints on the phase shifts of the input phase currents are satisfied.

9. The method according to claim 8, wherein the method comprises feeding the multi-phase converter via the three or more phase contacts that form primary-side contacts, wherein the multi-phase converter comprises no primary-side contact for a neutral conductor.

10. The method according to claim 8, wherein in a verification step the method comprises:
determining via the controller whether current magnitudes of the input phase current setpoints I1, I2, I3 are capable of being realised, wherein these are each equal to the assigned current limit value I1d, I2d, I3d; and
otherwise reducing via the controller the current magnitude whose current limit value is the largest of the current limit values.

11. The method according claim 8, wherein the method comprises determining via the controller the current magnitudes of the input phase current setpoints I1, I2, I3 based on fictitious delta current magnitudes J1, J2, J3, wherein the following equations apply
$$I {1}^{2} = J {1}^{2} + J {2}^{2} + J 1 \cdot J 2 ,$$
$$I {2}^{2} = J {2}^{2} + J {3}^{2} + J 2 \cdot J 3 ,$$
$$I {3}^{2} = J {3}^{2} + J {1}^{2} + J 3 \cdot J 1.$$

12. The method according to claim 11, wherein the method comprises determining via the controller the phase shifts of the input phase current setpoints as
$${φ}_{1} = 30 ° - arccos \frac{I {1}^{2} + J {1}^{2} - J {2}^{2}}{2 I 1 \cdot J 1} ,$$
$${φ}_{2} = 30 ° - arccos \frac{I {2}^{2} + J {2}^{2} - J {3}^{2}}{2 I 2 \cdot J 2} ,$$
$${φ}_{3} = 30 ° - arccos \frac{I {3}^{2} + J {3}^{2} - J {1}^{2}}{2 I 3 \cdot J 3} .$$

13. The method according to claim 8, wherein the method comprises controlling in a closed-loop control the converter circuit via the controller to a maximal power uptake at the phase contacts, with a constraint that the current magnitudes of the input phase current setpoints I1, I2, I3 are equal.

14. The method according to claim 8, wherein the method comprises:
receiving or storing via the controller load limitation information on at least one of the phase contacts; and
reducing via the controller the current limit value of this phase contact in accordance with the load limitation information.
